(19) United States
(12) Patent Application Publication
(10) Pub. No.: US 2005/0115508 A1
(43) Pub. Date: Jun. 2, 2005

(54) Healthy pet appropriate food and drink table

(76) Inventor: Cynthia L. Little, Marathon, NY (US)

Correspondence Address: Donald W. Meeker;Patent Agent, 924 East Ocean Front #E, Newport Beach, CA, 92661, US

(21) Appl. No.: 10/726,281

(22) Filed: Dec. 1, 2003

(51) Int. Cl. A01K 1/10

(52) U.S. Cl. 119/61.5

(57) ABSTRACT

An elevated pet feeder with removable easily cleaned food and water containers which fit into a table platform structured in a pet specific size and shape made of natural wood material of a heavy weight with heavy legs to hold the feeder in place while the pet eats and drinks. The table surface comprises indentations, which enable the pet's neck to be positioned adjacent to the food and water containers.

### BACKGROUND OF THE INVENTION

1. Field of the Invention

The present invention relates to pet feeding apparatus and in particular to a pet feeding table dispensing both pet food and water and structured to a pet appropriate height and configuration for pet health and convenient access.

2. Description of the Prior Art

It has been found that the health of a dog, cat, or other such pet can be improved by providing a feeding position which is raised above the ground or floor. This reduces or eliminates the need for the dog to position its head downward during feeding. Among the benefits of an elevated feeding position are that the pet swallows less air during feeding. Moreover, pets suffering from arthritis can feed with reduced pain. Overall, an elevated feeding position provides a more comfortable and convenient as well as a healthy feeding position.

While there are structures known in the prior art which provide an elevated position for a feeding vessel, these structures have many significant disadvantages. The disadvantages include feeding vessels which are fixed to the support structure or to the floor, or feeding vessels which have curved bottom surfaces. These types of feeding vessels are inconvenient to fill with foodstuff, such as pet food or water. Moreover, such feeding vessels cannot be placed on the ground or floor for use separate from the support structure.

Feeder apparatuses of the prior art have included many different designs. For small animals, a feeder apparatus may include non-removable feeder vessels which are typically molded into a one-piece feeder apparatus of approximately 2-3 inches in height. Obviously, a feeder apparatus of this size does not require legs for support but does not provide adequate height for healthy eating.

Many prior art pet feeders are fabricated of synthetic materials, such as plastic. These synthetic materials are fabricated of materials which may be unhealthy for the pet to consume if a piece of the feeder is chipped off and eaten and some of the synthetic materials also give off unhealthy gases. Some of the synthetic materials, especially if they become scratched are difficult to clean. They are also lightweight and tend to move around as the pet is trying to eat.

For larger animals, those requiring a feeder apparatus having a height of six inches or greater, feeder apparatuses of the art tend to be large structures with legs for support or of a multi-piece box design. A feeding apparatus with foldable or adjustable legs tend to have support problems. Thus, in U.S. Pat. No. 5,509,376 it is taught a feeding apparatus for larger animals wherein the legs are hollow to allow ballast to provide support, which requires filling up the legs with water or sand or something else that can be poured in for weight. In some structures, the unit may have foldable legs to provide a reduced “footprint” of the feeder assembly for shipping or display. Such detachable or folding legs tend to become unstable during prolonged use.

Prior art U.S. Pat. No. 5,509,376, issued Apr. 23, 1996 to Tsengas, depicts an animal feeder assembly that provides food and water at an elevated position from a support surface and is therefore particularly suited for feeding large dogs in a manner which avoids digestive and posture problems associated with feeding such animals from containers positioned at the level of the support surface. The feeder assembly comprises a feeder tray and a plurality of hollow legs releasably attached to the feeder tray. Each of the hollow legs are capable of holding ballast material such as sand or water for lowering the center of gravity of the assembly relative to the support surface, thereby enhancing the stability of the assembly and inhibiting the animal form transporting the feeder assembly from the preferred feeding location. The tray and legs are preferably made of blow molded plastic and the tray is formed to include a closed interior cavity, each of which facilitates cleaning the assembly. Each leg is releasably attached to the tray and may be releasably locked to a receptacle formed in a bottom surface of the tray.

Prior art U.S. Pat. No. 6,209,487, issued Apr. 3, 2001 to Quinlan, shows an improved elevated animal feeder apparatus that provides food at an elevated position to provide a more comfortable and healthy feeding position for animals. The animal feeder apparatus includes a support structure having removable feeder vessels. The support structure is of a unitary molded plastic construction and is configured for nested stacking with like feeder assemblies for convenient and compact storage and handling. The base of the top surface of the support structure is generally oblong in shape with flared side surfaces to provide support. The top surface has openings for receiving feeding vessels. A preferred feeding vessel has a raised back surface to act as a back splash. The raised back splash may also include a notch for easily removing the feeding vessel form the support structure for filling and cleaning the vessel. The feeding vessel has a novel shape, having the outline of a bone.

Prior art U.S. Pat. No. D446,611, issued Aug. 14, 2001 to Gunter, claims the design for a height adjustable dog and cat feeding table with removable feeding containers.

Prior art U.S. Pat. No. 2,841,114, issued Jul. 1, 1958 to Grant, describes an improved multiple dish racking, supporting and serving stand susceptible of feasible use when feeding house pets, for example, cats, dogs and the like.

Prior art U.S. Pat. No. D424,759, issued May 9, 2000 to Sipka, discloses an ornamental design for an elevated, adjustable height dog feeder. The dog feeder has recesses in the top created to receive removable bowls.

Prior art U.S. Pat. No. 4,044,723, issued Aug. 30, 1977 to Fitzpatrick, indicates an animal feeding apparatus particularly suitable for feeding large dogs such as Great Danes, includes a table having angularly disposed legs which support the table top in a substantially braced position above a floor surface and at a feeding level which may be chosen with reference to the normal height of the animal to be fed. Container means located in the table top provides for holding a serving of dog food in a raised position. A cover element is formed with hinge means along one edge of the table top and is movable into a position to overlie the top. The cover element is recessed to receive the container means therethrough in an upwardly projecting position when the cover is closed, and portions of the container means are engaged between the cover and top so that no displacement of the container means takes place during the feeding period.

Prior art U.S. Pat. No. D377,244, issued Jan. 7, 1997 to Steininger, illustrates the ornamental design for a pet dining table, showing an elevated feeding bench with two recesses for holding the pet food and water dishes.

Prior art U.S. Pat. No. D293,947, issued Jan. 26, 1988 to Younker, concerns the ornamental design for an elevated pet feeder, wherein the pet feeder is made of wood. Two recesses are created in the top surface of the feeder for holding bowls. A novel design of a cat's face is placed on each end of the pet feeder.

What is needed is an elevated pet feeder with removable easily cleaned food and water containers fit into a table platform structured in a pet specific size and shape made of natural material of a heavy weight with heavy legs to hold the feeder in place while the pet eats and drinks.

### SUMMARY OF THE INVENTION

A primary object of the present invention is to provide a pet feeding and drinking table having a pet specific shape (bone for a dog and fish for a cat, both sized for different sizes of the pets) with the bowls and legs sized appropriately for pet size and type with indentations in the pet specific table shape which enable the pets to position themselves immediately adjacent to the feeding bowls.

A further object of the present invention is to provide an elevated pet feeder with removable easily cleaned food and water containers fit into a table platform structured in a pet specific size and shape made of natural material of a heavy weight with heavy legs to hold the feeder in place while the pet eats and drinks.

Another object of the present invention is to provide an elevated pet feeder, which by raising the containers up from the ground provides a comfortable and healthy feeding position, in which the posterns and spinal alignment are protected and the pet swallows less air while eating.

One more object of the present invention is to provide bowls, which are preferably stainless steel to be highly scratch resistant and durable and easily removed for washing and easily replaced with food and water in them.

In brief, a pet feeding table device provides a healthy pet specific easy bowl access eating and drinking environment for pets. The device comprises a pair of round open top containers (feeding and drinking bowls) for holding pet food and water therein. Each of the containers has a top circular opening sufficiently large to permit a head of an appropriate size and type of pet to fit into the container for eating and drinking and inwardly sloping sides to permit easy access to everything in the container. The opening of each bowl has a protruding lip around the edge, which holds the bowl in place when positioned within the opening of the pet table surface. The containers are preferably fabricated of stainless steel for easy cleaning and durability.

The pet table surface is formed of a thick heavy weight piece of wood and the legs are formed of thick heavy weight pieces of wood so that the pet feeding device is sufficiently heavy to remain in a stationary position while the pet eats and drinks. The elevated pet feeding table device is structured with a pet specific shape (bone for a dog and fish for a cat) and is sized for specific sizes of pets. The bowls and legs are also sized appropriately for pet size and type. The pet specific shaped pet table surface has indentations, which enable the pet to position itself immediately adjacent to the feeding bowls.

An advantage of the present invention is that the food and water are elevated.

Another advantage of the present invention is that the feeder will remain stationary as the pet eats.

An additional advantage of the present invention is that the pet may readily position itself close to the food.

One more advantage of the present invention is that the shape is pet specific.

Yet another advantage of the present invention is that the size is pet specific.

A further advantage of the present invention is that the height is pet specific.

Still another advantage of the present invention is the bowls are removable.

A final advantage of the present invention is that it provides a comfortable and healthy feeding position.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of a double removable bowl pet feeder for dogs with a pet table eating surface having a bone configuration indented adjacent to the bowls for easy pet access to each bowl and showing the bowls aligned for insertion in the openings in the pet table surface;

FIG. 1A is a perspective view of a smaller size for smaller dogs of the double removable bowl pet feeder for dogs of FIG. 2 with a table top having a reduced size bone configuration, reduced container size, and reduced size legs;

FIG. 2 is a perspective view of a double removable bowl pet feeder for cats with a table top having a fish configuration indented adjacent to the bowls for easy pet access to each bowl;

FIG. 2A is a perspective view of a smaller size for smaller cats of the double removable bowl pet feeder for cats of FIG. 2 with a table top having a reduced size fish configuration, reduced container size, and reduced size legs.

### BEST MODE FOR CARRYING OUT THE INVENTION

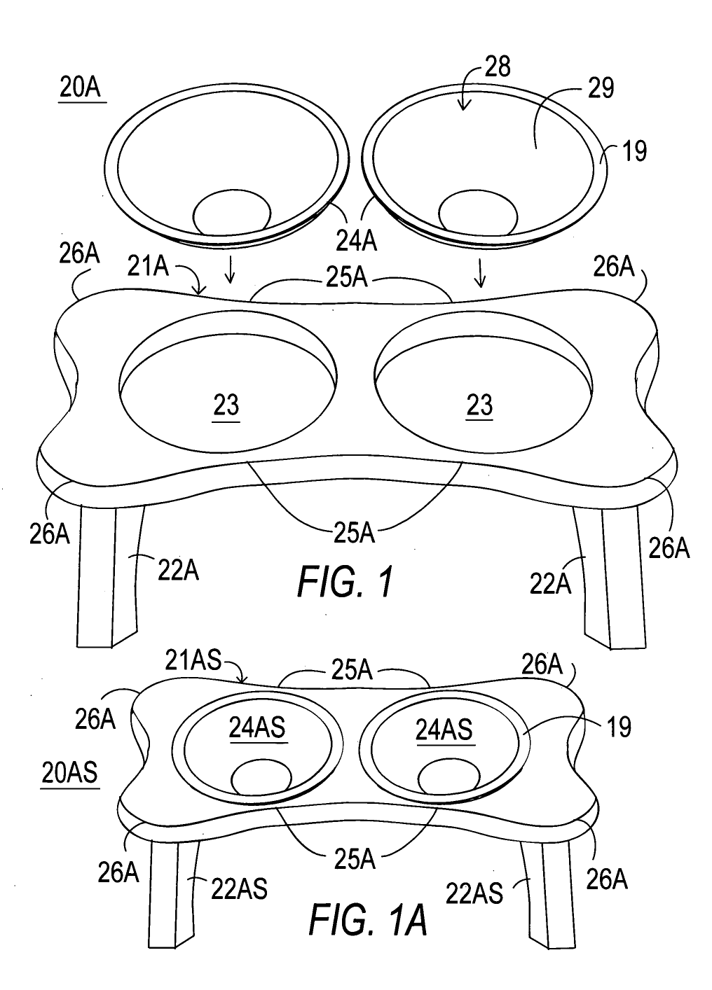

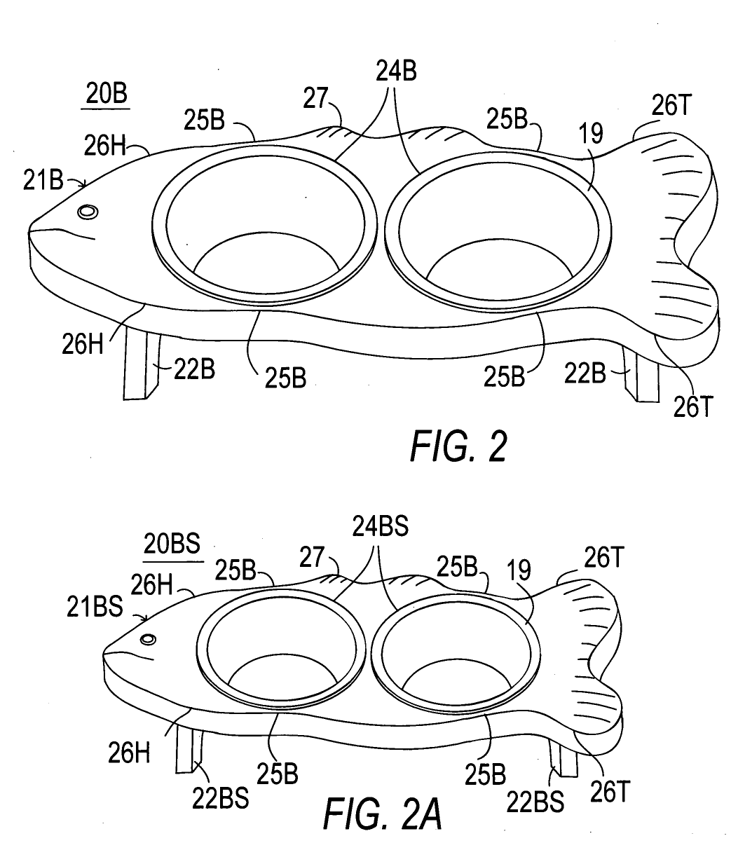

In FIGS. 1, 1A, 2, and 2A, a pet feeding table device 20A, 20AS, 20B, and 20BS provides a healthy pet specific easy bowl access eating and drinking environment for pets. The device 20A, 20AS, 20B, and 20BS comprises a pair of round open top containers 24A, 24AS, 24B, and 24BS for receiving pet food and water therein, which are preferably stainless steel for easy clean up and scratch resistant durability. Each of the containers 24A, 24AS, 24B and 24BS has a top circular opening 28 sufficiently large to permit a head of an appropriate size and type of pet to fit into the container 24A, 24AS, 24B and 24BS for eating and drinking and inwardly sloping sides 29 to permit easy access to everything in the container 24A, 24AS, 24B and 24BS. Each of the bowls 24A, 24AS, 24B and 24BS have a protruding lip 19 extending outwardly from the circular opening 28, as seen in FIG. 1.

The device 20A, 20AS, 20B, and 20BS also includes a pet table eating surface 21A, 21AS, 21B and 21BS that comprises a thick slab of elongated wood structured in a pet specific shape for a particular size and type of pet, such as a small, medium or large bone for a small, medium or large sized dog, as in FIGS. 1 and 1A, or a small, medium or large fish for a small, medium or large cat, as in FIGS. 2 and 2A.

The pet table eating surface 21A, 21AS, 21B and 21BS is supported by four heavy thick rigid legs 22A, 22AS, 22B and 22BS securely attached below the pet table eating surface 21A, 21AS, 21B and 21BS. The legs 22A, 22AS, 22B and 22BS are sized for a particular size and type of pet, such as the small, medium and large size legs 22A and 22AS for small, medium and large size dogs in FIGS. 1 and 1A, and the small, medium and large size legs 22B and 22BS for cats in FIGS. 2 and 2A.

The pet table eating surface 21A, 21AS, 21B and 21BS has two round, spaced bowl openings 23 in the pet table eating surface 21A, 21AS, 21B and 21BS that are structured to receive the pair of bowls 24A, 24AS, 24B and 24BS therein. Each of the openings 23 are sufficiently large to permit one of the pair of containers 24A, 24AS, 24B and 24BS to be inserted therein with the protruding lip 19 contacting the pet table eating surface 21A, 21AS, 21B and 21BS to retain the container 24A, 24AS, 24B and 24BS in the opening 23.

The pet table eating surface 21A, 21AS, 21B and 21BS has a pet table eating surface width and a pet table eating surface length extending beyond the bowl openings 23 a sufficient distance to accommodate the rigid attachment of the four legs 22A, 22AS, 22B and 22BS spaced apart from the bowl openings 23 with the legs 22A, 22AS, 22B and 22BS positioned outside of the containers 24A, 24AS, 24B and 24BS on both the pet table eating surface width and length to provide a broad support base so that the pet eating table 20A, 20AS, 20B and 20BS is not easily tipped over by the pet.

The pet table eating surface 21A, 21AS, 21B and 21BS is structured in a pet specific shape appropriate to the size and type of pet. The pet table eating surface 21A, 21AS, 21B and 21BS has indentations 25A and 25B in the pet specific shape intruding into the pet table eating surface 21A, 21AS, 21B and 21BS to a point immediately adjacent to the containers 24A, 24AS, 24B and 24BS to provide a close pet access space so that a neck of the pet is positioned immediately adjacent to the container 24A, 24AS, 24B and 24BS for easy access to the contents of the container.

In FIG. 1, the pet specific shape of the pet table eating surface 21 A comprises a dog bone shape of a specific size coordinated with specifically sized containers 24A and specifically sized legs 22A for a dog of a specific size. The pet table top 21A comprises rounded expanded bone ends 26A at each of two ends of the pet table top 21A to receive two legs 22A at each end. The indentations on either side of the pet table eating surface 21A form an indented elongated straight bone center portion 25A between the rounded ends 26A of the bone shape 21A, which enable the positioning of a neck of a dog to be positioned immediately adjacent to each of the pair of containers 24A along a portion of the straight bone center portion 25A.

In FIG. 1A, the pet feeder device 20AS is a smaller size for smaller dogs and comprises a pet feeder table 21AS having a reduced size bone configuration, reduced container size 24AS, and reduced size legs 22AS.

In FIG. 2, the pet specific shape of the pet table eating surface 21B comprises a fish shape of a specific size coordinated with specifically sized containers 24B and specifically sized legs 22B for a cat of a specific size. The pet table eating surface 21B has a fish tail portion 26T extending outwardly from the bowl openings 23 to receive two of the legs 22B attached thereto. The pet table eating surface 21B also has a fish head portion 26H extending outwardly from the bowl openings 23 to receive two of the legs 22B. An indentation in a first edge of the pet table eating surface 21B comprises an indented portion 25B between the fish tail portion 26T and a center fish fin portion 27 enabling a neck of a cat to be positioned adjacent to one of the pair of containers 24B and a second indented portion 25B between the fish head portion 26H and a center fish fin portion 27 enabling a neck of a cat to be positioned adjacent to the other of the pair of containers 24B. The opposite second edge of the pet table eating surface 21B also has an indentation that comprises two indented portions 25B, one of the indented portions 25B positioned close to the rim 19 of the each of the containers 24B, enabling a neck of a cat to be positioned adjacent to one of the pair of containers 24B.

In FIG. 2A, the pet feeder device 20BS is a smaller size for smaller cats and comprises a pet feeder table 21BS having a reduced size fish configuration, reduced container size 24BS, and reduced size legs 22BS.

The pet table surface 21A, 21AS, 21B and 21BS is formed of a thick heavy weight piece of wood and the legs 22A, 22AS, 22B and 22BS are formed of thick heavy weight pieces of wood so that the pet feeding device 20A, 20AS, 20B, and 20BS is sufficiently heavy to remain in a stationary position while the pet eats and drinks. The containers 24A, 24AS, 24B, and 24BS are preferably fabricated of stainless steel for easy cleaning and durability.

In practice, a pet owner chooses a pet feeding table device 20A, 20AS, 20B, or 20BS to match the species and size of their pet, for example a small cat would require the smaller fish shaped feeder 20BS, seen in FIG. 2A. The pet should be able to access the food containers 24A, 24AS, 24B, and 24BS without having to lower their heads. The bowls 24A, 24AS, 24B, and 24BS are placed into the holes 23 and the pet food and water is then placed inside of the bowls 24A, 24AS, 24B, and 24BS. When the feeder 20A, 20AS, 20B, and 20BS is placed on the floor the pet feeder surface 21A, 21AS, 21B, and 21BS is the appropriate height for the size and type of pet and the pet can get immediately adjacent to the bowls 24A, 24AS, 24B, and 24BS. When the pet is finished eating the bowls 24A, 24AS, 24B, and 24BS, which are preferably stainless steel are easily removed for washing and easily replaced with food and water in them.

It is understood that the preceding description is given merely by way of illustration and not in limitation of the invention and that various modifications may be made thereto without departing from the spirit of the invention as claimed.

1. A pet feeding table device to provide a healthy pet specific easy bowl access eating and drinking environment for pets, the device comprising:
a pair of round open top stainless steel containers for receiving pet food and water therein, the stainless steel containers being scratch-free, easy cleaning and durable, each of the containers having a top circular opening sufficiently large to permit a head of an appropriate size and type of pet to fit into the container for eating and drinking and inwardly sloping sides to permit easy access to everything in the container, each of the bowls having a protruding lip extending outwardly from the circular opening;
a pet table eating surface comprising a thick slab of elongated wood for a natural non-toxic eating surface, the wood structured in a pet specific shape for a specific size and type of pet, the pet table eating surface supported by four heavy thick rigid legs securely attached below the pet table eating surface, the legs sized for a particular size and type of pet, the pet table eating surface having two round spaced bowl openings holes in the pet table eating surface structured to receive the pair of bowls therein, each of the holes sufficiently large to permit one of the pair of containers to be inserted therein with the protruding lip contacting the pet table eating surface to retain the container in the hole, the pair of bowls easily removable for cleaning by pushing up each of the pair of bowls through the holes, the pet table eating surface having a pet table eating surface width and a pet table eating surface length extending beyond the bowl openings a sufficient distance to accommodate a rigid attachment of the four legs spaced apart from the bowl openings with the legs positioned outside of the containers on both the pet table eating surface width and length to provide a broad support base so that the pet eating table is not easily tipped over by the pet, the pet table eating surface having at least one indentation in the pet specific shape intruding into the pet table eating surface to a point immediately adjacent to each one of the containers to provide a close pet access space so that a neck of the pet is positioned immediately adjacent to the container for easy access to the contents of the container.

2. The device of claim 1 wherein the pet specific shape of the pet table eating surface comprises a dog bone shape of a specific size coordinated with specifically sized containers and specifically sized legs for a dog of a specific size, the pet table top comprising rounded expanded bone ends at each of two ends of the pet table top to receive two legs at each end, the at least one indentation comprising an indented elongated straight bone center portion between the rounded ends of the bone shape enabling the positioning of a neck of a dog to be positioned immediately adjacent to each of the pair of containers along a portion of the straight bone center portion.

3. The device of claim 1 wherein the pet specific shape of the pet table eating surface comprises a fish shape of a specific size coordinated with specifically sized containers and specifically sized legs for a cat of a specific size, the pet table eating surface having a fish tail portion extending outwardly from the bowl openings to receive two of the legs attached thereto and a fish head portion extending outwardly from the bowl openings to receive two of the legs, the indentation comprising at least one first indented portion between the fish tail portion and a center fish fin portion enabling a neck of a cat to be positioned adjacent to one of the pair of containers and at least one second indented portion between the fish head portion and a center fish fin portion enabling a neck of a cat to be positioned adjacent to the other of the pair of containers.

4. The device of claim 1 wherein the pet table surface is formed of a thick heavy weight piece of wood and the legs are formed of thick heavy weight pieces of wood so that the pet feeding device is sufficiently heavy to remain in a stationary position while the pet eats and drinks.
